(19) United States
(12) Patent Application Publication
(10) Pub. No.: US 2008/0249898 A1
(43) Pub. Date: Oct. 9, 2008

(54) Method, system, and apparatus to identify products in proximity to mobile device

(75) Inventor: Nitesh Ratnakar, Elkins, WV (US)

Correspondence Address: NITESH RATNAKAR, ROUTE 3,, BOX 179-A, ELKINS, WV, 26241, US

(73) Assignee: NOVATION SCIENCE, LLC, Elkins, WV (US)

(21) Appl. No.: 12/140,684

(22) Filed: Jun. 17, 2008

(51) Int. Cl. G06Q 30/00; G01S 5/00

(52) U.S. Cl. 705/27; 342/357.09

(57) ABSTRACT

Present invention disclosed a method of product search comprising of first product database containing seller information, seller product information, and product location; second product database containing buyer product request; first application in mobile device having means to determine mobile device location at pre determined intervals and having means to automatically communicate mobile device location to second application; second application having means to match first and second product databases and mobile device location at pre determined intervals to generate local matching products database; mobile device having display means for products contained in local matching product database. According to another aspect of the invention, a method to inform sellers of potential buyers in proximity of seller location is disclosed.

### BACKGROUND

It is a common practice to sell products on the internet using electronic devices such as personal computers and mobile devices. Buyers usually prefer to buy products in close proximity to their location. It makes for delivery of products fast, reliable, and cost effective. It also enables buyer to personally inspect and pick up products at their own convenience. Currently, web sites require input of postal code into web site search engine; where after products are displayed according to their proximity to input postal code. This is a useful method to search for local products when immobile devices, such as personal computer is used. However, with the convergence of internet with mobile devices, such as mobile phones, it is often impractical for user to remember postal code for frequently changing location of mobile device. There remains a need for technology to enable users search for products in proximity to current location of their mobile device. The convergence of GPS chipset, internet, and mobile devices present an opportunity to provide buyers with an application that will enable users to be automatically alerted of products in vicinity of current location of mobile device that match products users wish to buy without requiring manual location input.

### SUMMARY

Present invention disclosed a method of product search comprising of first product database containing seller information, seller product information, and product location; second product database containing buyer product request; first application in mobile device having means to determine mobile device location at pre determined intervals or pre defined events and having means to automatically communicate mobile device location to second application; second application having means to match first and second product databases and mobile device location at pre determined intervals to generate local matching products database; mobile device having display means for products contained in local matching product database. According to another aspect of the invention, a method to inform sellers of potential buyers in proximity of seller location is disclosed.

### BRIEF DESCRIPTION OF DRAWINGS

FIG. 1 shows the structure of seller product database.

FIG. 1b shows structure of mobile client product database.

FIG. 2 shows central server containing seller product database and mobile client product database.

FIG. 3 shows mobile device in communication with GPS satellite; mobile device transmitting mobile device location GPS coordinates to central server; central server containing seller product database, mobile client product database, and mobile device location GPS coordinates.

FIG. 4 shows a method, means, and apparatus for finding local products comprising of central server with artificial intelligent matching application to match seller product database, mobile client product database, and mobile device location GPS coordinates to generate a local matching product database; and having means to transmit local matching product database to corresponding mobile device.

FIG. 5 shows a method, means, and apparatus for finding local products comprising of central server containing seller product database; central server having means to transmit seller product database to one or more mobile devices; mobile device containing mobile client product database; mobile device having means to receive seller product database from central server; mobile device in communication with GPS satellite; mobile device having artificial intelligent matching application to match seller product database, mobile client product database, and mobile device location GPS co-ordinates to generate local matching product database.

FIG. 6 illustrates identical structure of seller product database in central server and seller product database in mobile device for method of local product search shown in FIG. 5.

FIG. 7 shows a method, means, and apparatus for finding local products comprising of mobile device having mobile client product database; mobile device in communication with GPS satellite; mobile device in communication link with central server; mobile device having means to transmit mobile client product database and mobile device location GPS coordinates to central server; central server having seller product database; central server having means to receive mobile client product database and mobile device location GPS coordinates; central server having artificial intelligent matching application to match seller product database, mobile client product database and mobile device location GPS coordinates to generate local matching product database; central server having means to transmit local matching product database to corresponding mobile device.

FIG. 8 shows a method, means, and apparatus for finding local products comprising of central server containing seller product database and mobile client product database; central server having artificial intelligent matching application to match seller product database with mobile client product database to generate matching product database; central server having means to transmit matching product database to corresponding mobile device; mobile device in communication link with GPS satellite to obtain current location GPS co-ordinates; mobile device having matching application to match matching product database and mobile device location GPS coordinates to generate local matching product database.

FIG. 9 is an illustration of artificial intelligent matching algorithm having means to match seller product database, mobile client product database; and mobile device location GPS co-ordinates according to seller product location GPS coordinates; to generate local matching products database.

FIG. 10 shows a method to determine geographic range for location based product search.

FIG. 11 shows a method, means, and apparatus for notifying sellers of mobile clients in proximity to seller location who are looking for seller products.

### DETAILED DESCRIPTION OF DRAWINGS

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out one or several purposes of the present invention. It is important, therefore, that the claims be regarded as including such equivalent constructions insofar as they do not depart from the spirit and scope of the present invention.

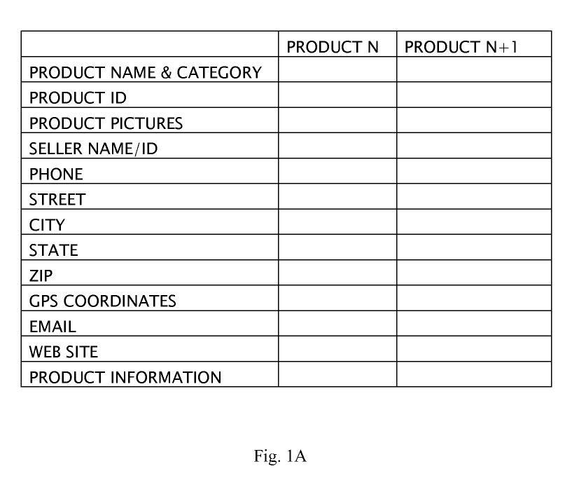

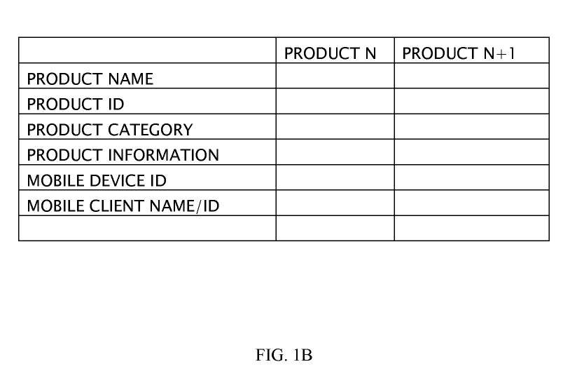

Product database comprises of seller and mobile client product databases. FIG. 1A shows seller product database structure containing data fields to capture product information and includes product name, product ID, product category, product image, seller information like seller name/ID, phone, web site, email, physical address of product location, GPS coordinates corresponding to physical location of product, and detail product information. Preferably, GPS coordinates corresponding to physical location of product is obtained from geo code database. Additionally product location can also be determined by triangulation of cellular towers and available access points corresponding to physical location of product. Seller product information can be in one or more of text, voice, image, and video formats. Mobile client product database structure, shown in FIG. 1B, contains data fields for product name, product ID, product category, detail product information, mobile device ID, and mobile client name/ID. Product information in mobile client product database can be in one or more of text, voice, image, and video formats. One of many existing mobile database programs may be used for seller and mobile client product databases. Currently in the field of mobile database, Sybase Inc.'s SQL Anywhere dominates the field, with about 68% of the total mobile database market. IBM's DB2 Everyplace is a relational database and enterprise synchronization server that extends enterprise applications to mobile devices. Microsoft SQL Server Compact and Oracle9i Lite are similar mobile databases. Products from lesser-known vendors, such as SQLBase from Gupta Technologies, LLC of Redwood Shores, Calif., and HanDBase from DDH Software Inc. of Lake Worth, Fla. may also suffice. Type of database used should not be considered limiting aspect of the invention. Preferably, means is provided for data input into seller product database and mobile client product database via a web interface using fixed location devices such as personal computer or mobile devices such as mobile phones. There is a representative entity in the central server/mobile device application for each seller, mobile client (buyer) and a GIS (Geographical Information Service) where all related information is stored. Product information uploaded into seller product database is entered into corresponding seller account. Similarly, product information uploaded into mobile client product database is entered into corresponding mobile client account.

Invention comprises of central server and mobile device applications containing built in artificial intelligent algorithms to help both sellers and buyers in product's negotiations. Mobile device application and central server application may be written in one or more mobile operating systems like Java ME, Windows Mobile, Brew, Symbian, Apple OS etc.

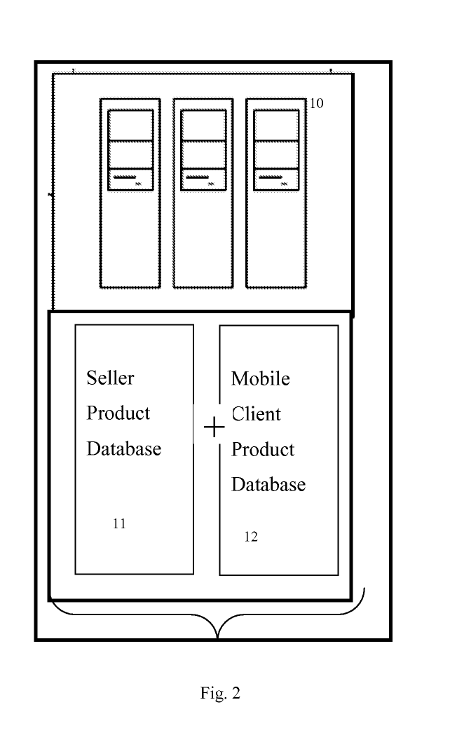

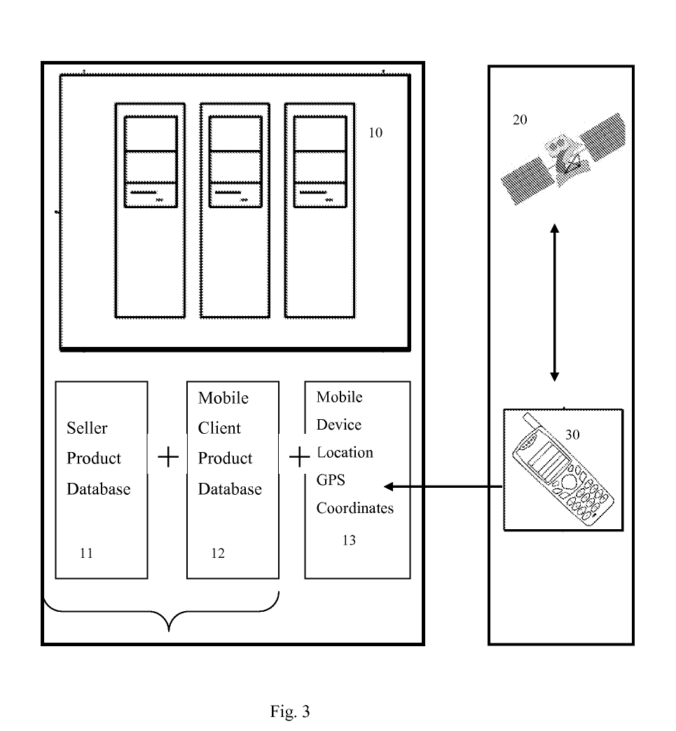

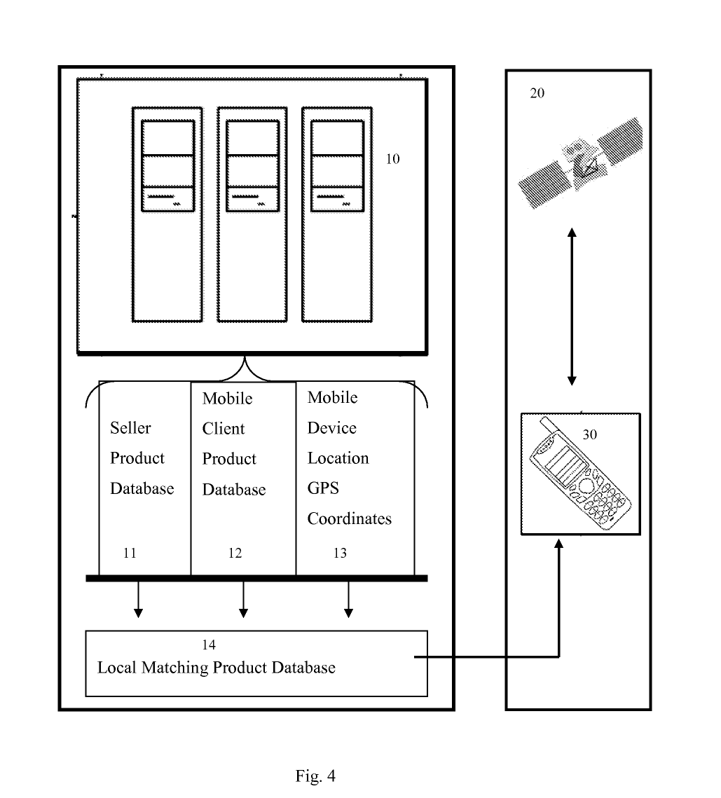

According to one method, as shown in FIGS. 2, 3 &4, a first application in mobile device (30) having means to receive satellite (20) position from the GPS system (GPS component module) and establish communication with the central server (Communication Component module) is provided. GPS component module is preferably programmed to obtain satellite position (20), as shown in FIGS. 3 &4, at pre determined intervals. This can be achieved by operatively connecting the GPS component module to a programmable timer device. Alternatively, GPS component module can be programmed to receive uninterrupted satellite position (20) while mobile device (30) is powered on; or can be programmed to receive satellite position (20) on an on demand basis. The communication component module is programmed to ping central server (10) with mobile device GPS coordinates, as shown in FIGS. 3, at pre determined intervals. Alternatively, communication component module is programmed to communicate with central server (10) on continuous basis or on an on demand basis. A second application is provided in central server (10) containing artificial intelligent matching algorithm having means to match mobile client product database (12), seller product database (11), and mobile device location GPS coordinates (13) according to product location GPS coordinates in seller product database; and generate local matching product database (14), as shown in FIG. 4. Matching algorithm attempts to find products in seller product database that match mobile client product request in order of proximity to mobile device location. Thereafter, local matching product database (14) is transmitted from central server (10) to corresponding mobile device (30). Means is provided in mobile device application to display information and location of products contained in local matching product database (14). The invention enables mobile device to be on the look out for products contained in mobile client product database in proximity to mobile device location; and notify mobile client of matching products on corresponding mobile device.

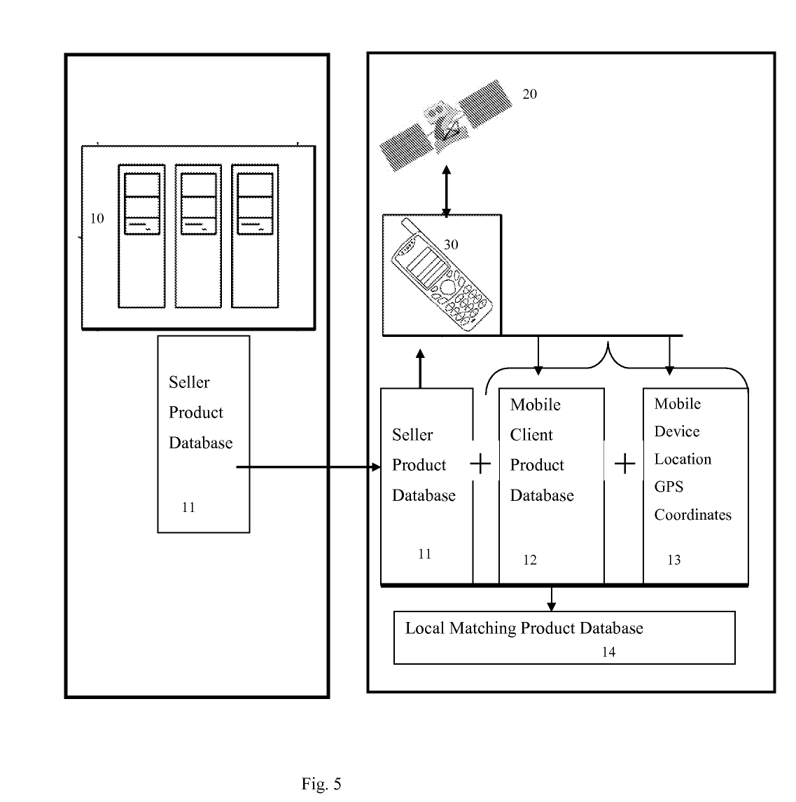

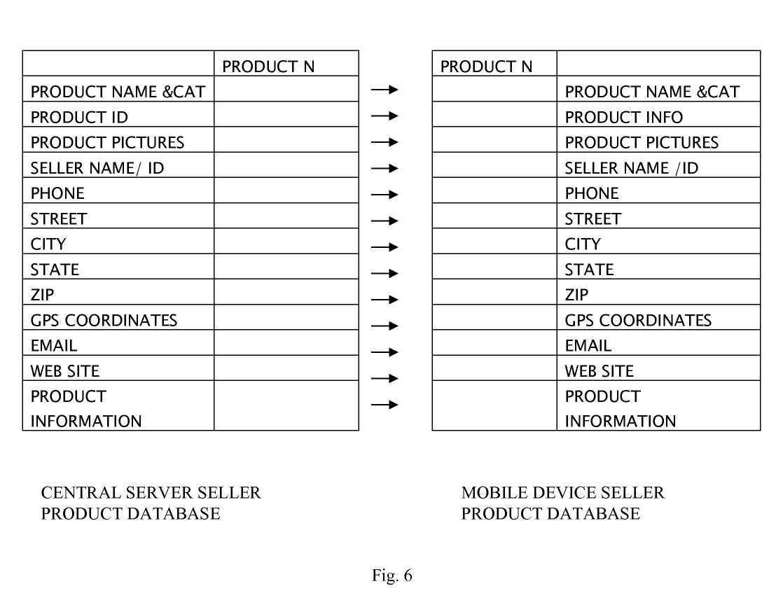

According to another method of the invention, shown in FIG. 6, seller product database (11) is provided in central server (10) with means for seller to enter product information into seller product database preferably via web interface. As shown in FIGS. 5 & 6, means is provided for mobile client to download seller product database (11) from central server (10) into mobile device (30); either at predetermined intervals or when user initiated. The database structure of seller product database (11) contains matching data fields in central server (10) and mobile device (30). Mobile client product database (12) is provided in mobile device (30) with means for mobile client to enter product information into corresponding mobile device; either via web interface or mobile device interface. A first application in mobile device (30) having means to receive satellite (20) position from the GPS system (GPS component module) is provided. GPS component module is preferably programmed to obtain satellite position (20) at pre determined intervals, upon user initiation, or continuously while mobile device is powered on. A second application is provided in mobile device (30) containing artificial intelligent matching algorithm having means to match mobile client product database (12), seller product database (11), and mobile device location GPS coordinates (13) according to product location GPS coordinates in seller product database (11); and generate local matching product database (14), as shown in FIG. 5. Matching algorithm attempts to find products in seller product database (11) that match requests in mobile client product database (12) in order of proximity to mobile device location, as shown in FIG. 5. Means is provided in mobile device (30) to display product information and product location contained in local matching product database (14). In essence, the invention enables mobile device (30) to be on the look out for product matching requests in mobile client product database in proximity of mobile device at pre determined intervals; and notify mobile client of product finding on corresponding mobile device.

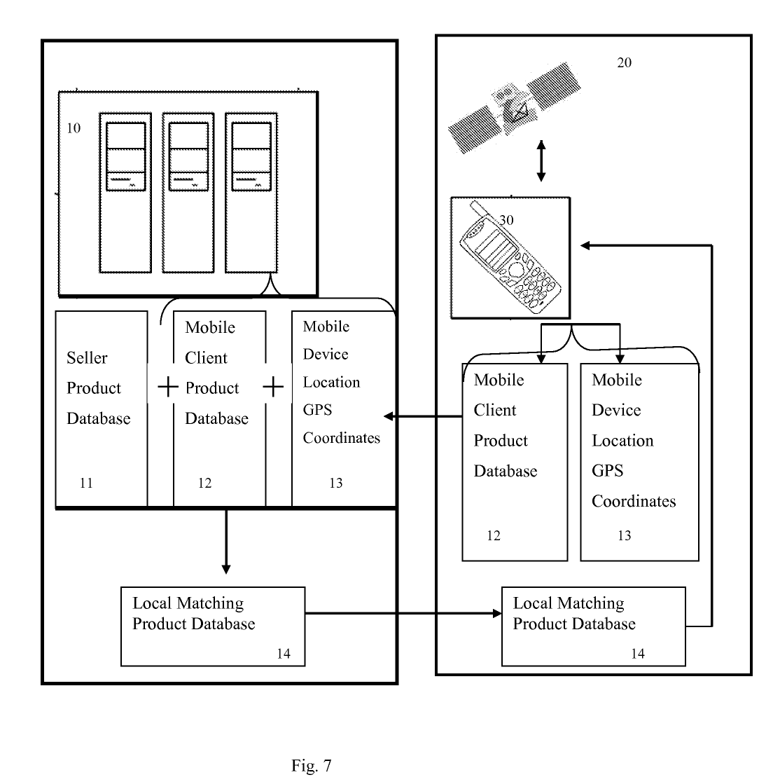

According to another method, shown in FIG. 7, mobile client product database (12) is provided in mobile device (30). Means is provided for mobile client to enter product request into mobile client product database (12); preferably via device interface; or alternatively via web interface. A first application in mobile device (30) having means to receive satellite (20) position from the GPS system (GPS component module) is provided. GPS component module is preferably programmed to obtain satellite position (20) at pre determined intervals, or alternatively upon user initiation, or continuously while mobile device is powered on. Means is provided in mobile device application to send transmit mobile client product database (12) and mobile device GPS coordinates to central sever at predetermined intervals; or alternatively upon user initiation, upon data input, or continuously while mobile device is powered on. Seller product database (11) is provided in central server (10) with means for seller to enter product information, preferably via web interface. A second application is provided in central server (10) containing artificial intelligent matching algorithm having means to match mobile client product database (12), seller product database (11), and mobile device location GPS coordinates (13) according to product location GPS coordinates in seller product database; and generate local matching product database (14), as shown in FIG. 7. Matching algorithm attempts to find products in seller product database that match mobile client product request in order of proximity to mobile device location. Thereafter, local matching product database (14) is transmitted from central server (10) to corresponding mobile device (30). Means is provided in mobile device application to display product information and product location contained in local matching product database (14). The invention enables mobile device to be on the look out for products matching requests in mobile client product database in proximity to mobile device location at pre determined intervals; and notify mobile client of product finding on corresponding mobile device.

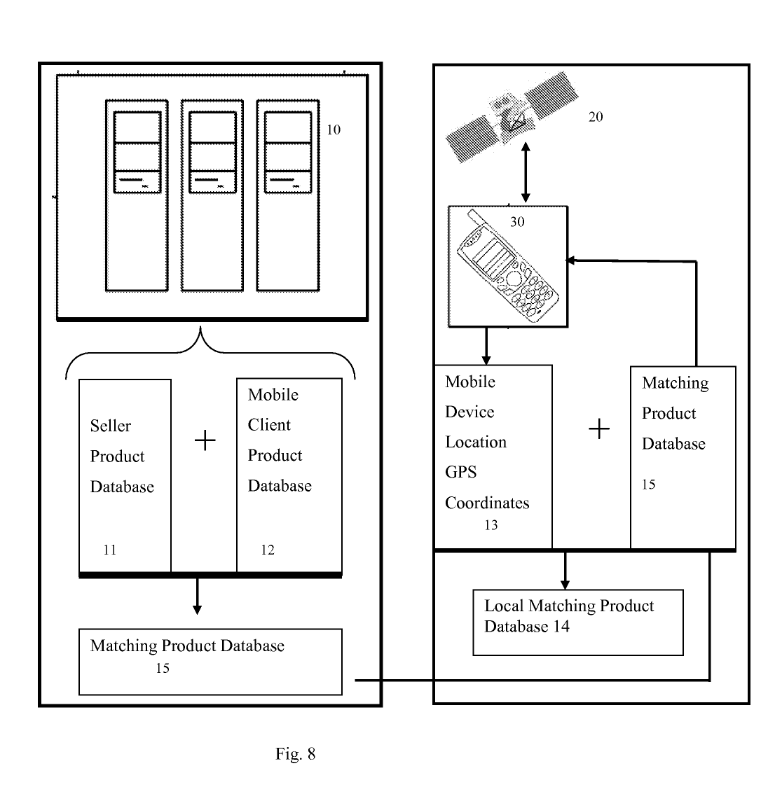

According to another method, shown in FIG. 8, mobile client product database (12) is provided in central server (10). Means is provided for mobile client to enter product request information into mobile client product database (12), preferably via web interface. Seller product database (11) is provided in central server (10) with means for seller to enter product information preferably via web interface. Second application is provided in central server comprising of artificial intelligent matching algorithm having means to match mobile client product database (12) with seller product database (11); and generate a matching product database (15). Further, central server application is programmed to transmit matching product database (15) to mobile device corresponding to mobile client. A first application in mobile device (30) having means to receive satellite (20) position from the GPS system (GPS component module) is provided. GPS component module is preferably programmed to obtain satellite position (20) at pre determined intervals; or alternatively upon user initiation, or continuously while mobile device is powered on. Another aspect of second application is provided in mobile device comprising of artificial intelligent matching algorithm having means to match mobile device location GPS coordinates with product location GPS coordinates of products contained in matching product database (15); and generate a local matching product database (14). Local matching product database (14) contains products in matching product database (15) that are in proximity to current location of mobile device (30). Means is provided in mobile device application to alert mobile client of products contained in local matching product database (14). An advantage of this method is that mobile device (30) does not need to be in communication with central server (10) every time mobile device location GPS coordinates (13) is updated. Preferably, matching product database (15) is uploaded from central server (10) into mobile device (30) at pre determined times or at pre determined events.

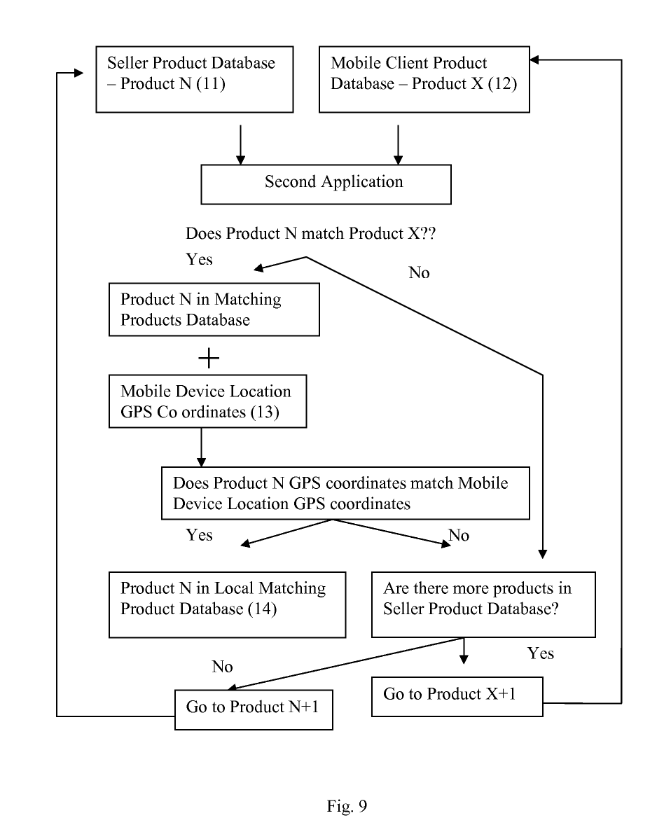

FIG. 9 shows a schematic representation of second application comprising of artificial intelligent matching algorithm having means to match seller product database (11) with mobile client product database (12) to generate matching products database; and thereafter match mobile device location GPS coordinates (13) with product location GPS coordinates in matching products database; and generate local matching products database (14).

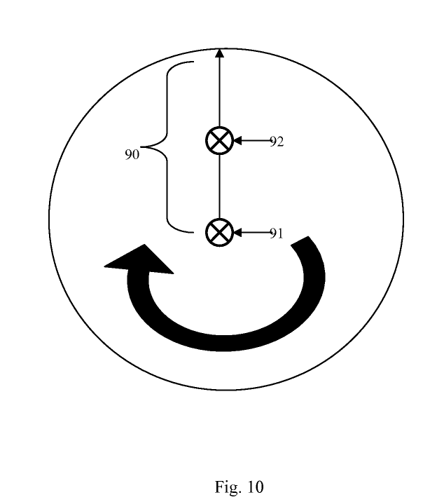

Preferably, mobile client is given option to determine acceptable range of geographic location to confine product search within a desired distance from mobile device location. According to one method shown in FIG. 10, acceptable geographic range is an area covering twice the distance between two consecutive locations of mobile device in 30 minute period (91, 92). This enables product location within 30 minutes of mobile device location in all directions (90). Preferably, mobile client is provided means to customize acceptable geographic range for product location according to user preference. Further, mobile device application preferably has a secondary storage in order to keep information about received maps, product, subscription and other additional information. The mobile device application preferably has additional mechanisms like power managing (activate/deactivate GPS and communications modules), use of ciphered communication etc.

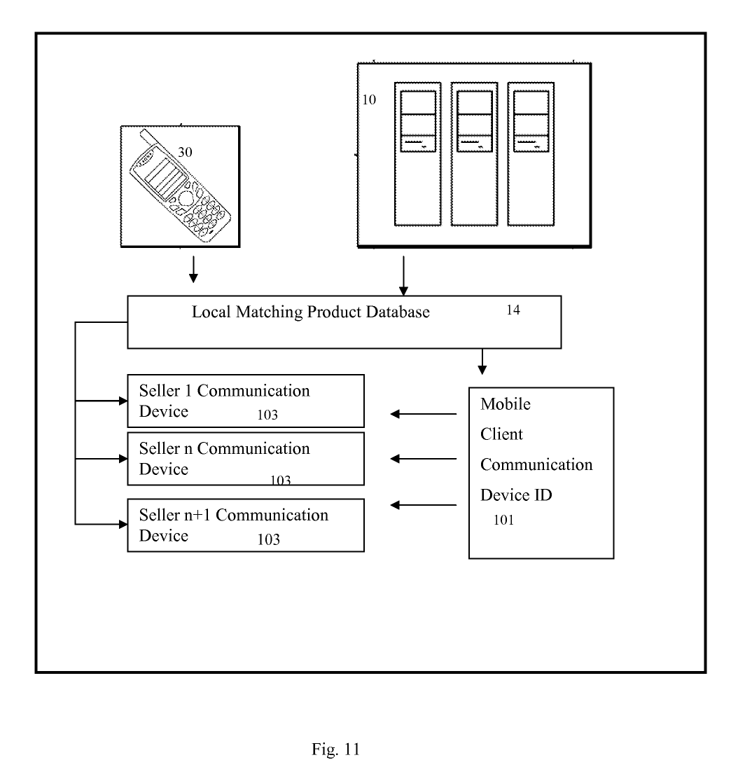

According to another aspect of the invention, as shown in FIG. 11, means is provided to notify seller of mobile clients in proximity of seller location looking for products contained in corresponding seller account in seller product database contained wither in central server (10) or mobile device (30). Means is provided in central server application (10) and mobile device application (30) to communicate with seller communication device (103). As mentioned in various methods, systems and apparatus of the invention disclosed in prior paragraphs, artificial intelligent matching algorithm is provided in second application contained in central server (10) or mobile device (30) to generate a local matching product database (14) based on proximity of products contained in seller product database (11) to current mobile device location. Additionally, means is provided in second application contained in central server or mobile device to determine communication device ID (103) of sellers corresponding to products contained in local matching product database (14); and thereafter transmit contact information (101) of corresponding mobile client to seller communication device (103). Seller communication device can be one or more of personal computer, phone, fax, pager, PDA, and mobile communication device such as mobile phones. Communication of mobile client contact information to seller communication device may be in one or more of email, SMS, voice message, or any other suitable formats.

I claim:

1. A method of product search comprising; 1) first product database containing seller product information and product location; 2) second product database containing buyer product request; 3) first application in mobile device having means to determine mobile device location and having means to communicate mobile device location to second application at predetermined events or intervals; 4) second application having means to match first and second product databases; and mobile device location at pre determined intervals to generate local matching products database; 5) mobile device having display means for products contained in location based matching product database.

2. The method of product search of claim 1 wherein product information is in one or more of text, voice, image, and video formats.

3. The method of product search of claim 1 wherein mobile device location is determined by one or more of GPS co-ordinates, cellular tower triangulation, and access point location.

4. The method of product search of claim 1 wherein product location is determined by one or more of GPS co ordinates, cellular tower triangulation, and access point location.

5. The method of product search of claim 1; wherein web interface is provided for data input into first and second product databases.

6. The product search of claim 1; wherein display means is provided in mobile device for display of product information.

7. A method of finding buyers comprising of; 1) first product database containing seller information, seller product information, and product location; 2) second product database containing buyer product request; 3) first application in mobile device having means to determine mobile device location at pre determined intervals or events and having means to automatically communicate mobile device location to second application; 4) second application having means to match first and second product databases; and mobile device location at pre determined intervals to generate local matching products database; 5) second application having means to determine seller contact information for products in local matching product database; and having communication means to communicate mobile client information to seller communication device.

8. The method of finding buyers of claim 7 wherein product information is in one or more of text, voice, image, and video formats.

9. The method of finding buyers of claim 7 wherein mobile device location is determined by one or more of GPS co-ordinates, cellular tower triangulation, and access point location.

10. The method of finding buyers of claim 7 wherein product location is determined by one or more of GPS co ordinates, cellular tower triangulation, and access point location.

11. The method of finding buyers of claim 7; wherein web interface is provided for data input into first and second product databases.

12. The method of finding buyers of claim 7; wherein display means is provided in communication device for display buyer information.

13. A system of product search comprising; 1) server having first product database containing seller product information and product location; 2) server having second product database containing buyer product request; 3) mobile device having first application having means to determine mobile device location at pre determined intervals or events; 4) server having second application having means to match first and second product databases to generate matching products database; 5) second application having means to transmit matching product database to corresponding buyer mobile device; 6) first application in mobile device having means to match mobile device location with product location in matching product database to generate local matching products database in order of proximity to mobile device location.

14. The product search method of claim 13 wherein product information is in one or more of text, voice, image, and video formats.

15. The product search method of claim 13 wherein mobile device location is determined by one or more of GPS co-ordinates, cellular tower triangulation, and access point location.

16. The product search method of claim 13 wherein product location is determined by one or more of GPS co ordinates, cellular tower triangulation, and access point location.

17. The product search of claim 13; wherein web interface is provided for data input into first and second product databases.

18. The product search of claim 13; wherein display means is provided in mobile device for display of product information.
